(19) United States
(12) Patent Application Publication
(10) Pub. No.: US 2011/0228421 A1
(43) Pub. Date: Sep. 22, 2011

(54) Detecting LTO Servo Patterns on Perpendicular Recorded Media

(75) Inventor: Christopher M. Watanabe, Broomfield, CO (US)

(73) Assignee: QUANTUM CORPORATION, San Jose, CA (US)

(21) Appl. No.: 12/724,712

(22) Filed: Mar. 16, 2010

(51) Int. Cl. G11B 19/02

(52) U.S. Cl. 360/69; G9B/19.001

(57) ABSTRACT

In one embodiment, a servo processing circuit comprises a correlation filter and a Lagrange interpolator peak detector coupled to the correlation filter. The correlation filter is operable to receive a first signal as input; correlate the first signal with a reference signal; and produce a second signal as output, wherein the second signal indicates a correlation between the first signal and the reference signal. The Lagrange interpolator peak detector is operable to receive the second signal as input; detect one or more peaks in the second signal; and produce a third signal as output, wherein the third signal indicates one or more peak locations of the peaks in the second signal.

### TECHNICAL FIELD

The present disclosure generally relates to detecting servo patterns on perpendicular recorded media using a correlation filter in each servo channel.

### BACKGROUND

Linear tape drive systems provide for high-density recording on multiple tracks of a magnetic tape. One type of tracking servo system employed by the linear tape drives is Linear Tape-Open (LTO). LTO is a magnetic tape data storage technology that employs a servo-based, closed-loop control mechanism. The servos are arranged in a frame that includes multiple sets of stripes oriented in a pre-defined servo pattern. Successive frames are arranged across the length of a magnetic tape. FIG. 1 illustrates an example LTO servo pattern. In this example, each servo frame includes four sets of stripes: 101, 102, 103, and 104. Stripe set 101 includes five stripes slightly tilted toward the right. Stripe set 102 includes five stripes slightly tilted toward the left (i.e., the opposite direction from stripe set 101). Stripe set 103 includes four stripes again slightly tilted toward the right. And stripe set 104 includes four stripes slightly tilted toward the left. The pattern repeats itself for each of the successive servo frames.

The LTO roadmap calls for successive increases in capacity and data transfer rate. Initially, the magnetic elements are recorded longitudinally along the magnetic tape in the direction of the tape movement. FIG. 2A illustrates an example of longitudinal recorded media 210. Magnetic elements 211 are aligned longitudinally with respect to the surface of magnetic tape 212, and depending on the orientation of the positive and negative poles, each magnetic element 211 represents either a 0 bit or a 1 bit. As the storage capacity of the LTO tape drives increases with each new generation, gradually, LTO longitudinal recorded media is near its maximum storage density. To address this problem, the perpendicular recorded media helps achieve higher storage densities by aligning the poles of the magnetic elements perpendicularly with respect to the surface of the magnetic tapes. FIG. 2B illustrates an example of perpendicular recorded media 220. Because magnetic elements 221 are aligned perpendicularly with respect to the surface of magnetic tape 222, each magnetic element 221 requires less tape space than would have been required had they been placed longitudinally (e.g., as illustrated in FIG. 2A) so that magnetic elements 221 may be placed closer together on magnetic tape 222, thus increasing the number of magnetic elements 221 that can be stored in a given area. Again, depending on the orientation of the positive and negative poles, each magnetic element 221 represents either a 0 bit or a 1 bit. A comparison between FIGS. 2A and 2B clearly shows that for the same amount of space on a magnetic tape, more magnetic elements can be placed as illustrated in FIG. 2B than as illustrated in FIG. 2A.

As track densities increase with each new generation of the LTO tape drives, the ability to precisely read servo patterns from and write servo patterns to a tape also needs to be improved.

### SUMMARY

The present disclosure generally relates to detecting servo patterns on perpendicular recorded media using a correlation filter in each servo channel.

In particular embodiments, a servo processing circuit comprises a correlation filter and a Lagrange interpolator peak detector coupled to the correlation filter. The correlation filter is operable to receive a first signal as input; correlate the first signal with a reference signal; and produce a second signal as output, wherein the second signal indicates a correlation between the first signal and the reference signal. The Lagrange interpolator peak detector is operable to receive the second signal as input; detect one or more peaks in the second signal; and produce a third signal as output, wherein the third signal indicates one or more peak locations of the peaks in the second signal.

These and other features, aspects, and advantages of the disclosure are described in more detail below in the detailed description and in conjunction with the following figures.

### BRIEF DESCRIPTION OF THE DRAWINGS

FIG. 1 illustrates an example LTO servo pattern.

FIG. 2A illustrates an example of longitudinal recorded media.

FIG. 2B illustrates an example of perpendicular recorded media.

FIG. 3 illustrates an example cross correlation channel.

FIG. 4 illustrates an example correlation filter.

FIG. 5 illustrates an example set of coefficients for a correlation filter.

FIG. 6 illustrates an example input top trace and an example output bottom trace of the correlation filter.

FIG. 7 illustrates an example method for detecting servo pattern on a perpendicular recorded media.

### DETAILED DESCRIPTION

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

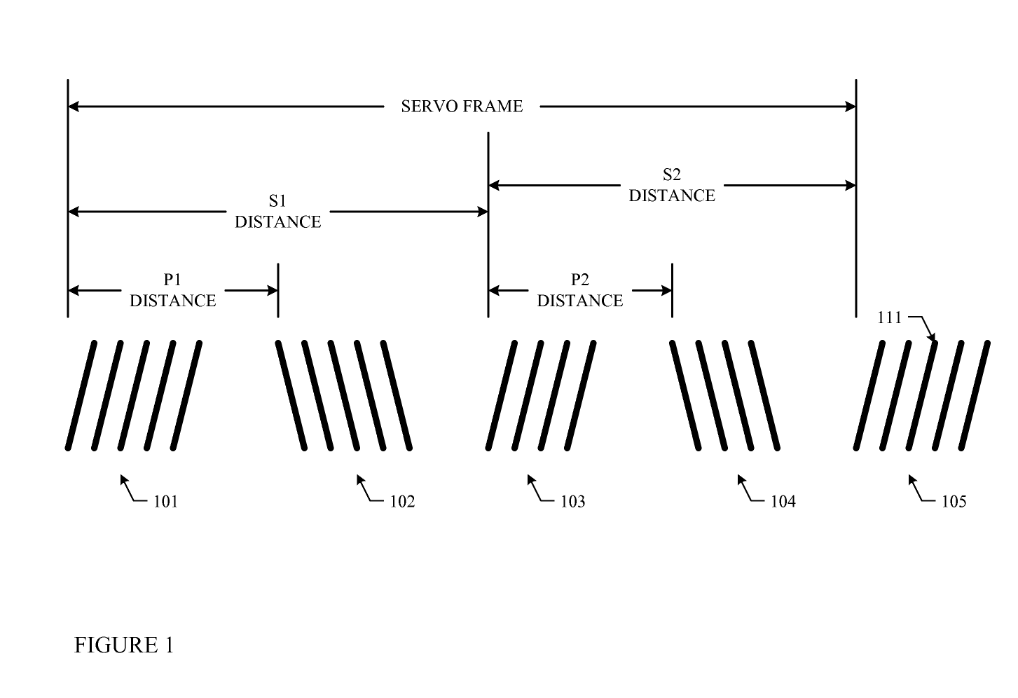

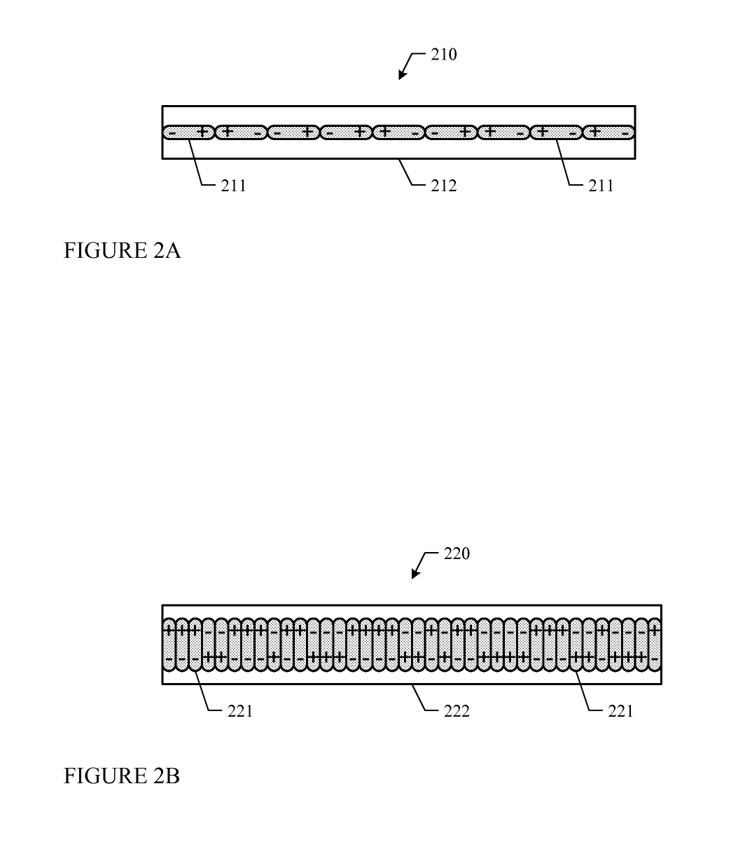

With LTO tape drives, to read the data recorded on a magnetic tape, a servo read head of a LTO tape drive needs to determine the pattern of each servo frame. This means that the locations of the stripes that form the servo patterns on the magnetic tape need to be determined. As illustrated in FIG. 1, a single stripe 111 has a small width. As the magnetic tape traverses, a servo read head encounters each individual stripe 111 in succession. When the servo read head moves from the tape surface onto a stripe 111, there is transition, called a positive transition. When the servo read head moves from the stripe 111 back to the tape surface, there is another transition, called a negative transition. Thus, with respect to each single stripe 111, there are two transitions. Then within each servo frame, the total number of transitions equals two times the number of stripes forming the servo frame. Consequently, the locations of the stripes on a magnetic tape may be determined by detecting these positive and negative transitions. Essentially, one looks for changes in a waveform representing the signals from a servo read head to locate peaks in the waveform, which correspond to the transitions. The actual stripe locations are expressed as distances between the individual sets of stripes. As illustrated in FIG. 1, P1 distance is the distance between stripe sets 101 and 102; P2 distance is the distance between stripe sets 103 and 104; S1 distance is the distance between stripe sets 101 and 103; and S2 distance is the distance between stripe sets 103 and 105 (note that strip set 105 is the first stripe set of the next servo frame).

LTO tape drives use a time-based servo, which requires the detection of the time distances between the individual stripes. The stripes are pulses written on a magnetic tape. The location of each peak, when detected, may be expressed as a time offset (e.g., a percentage of time) with reference to two consecutive data samples. For example, for a peak located between two consecutive data samples, its location may be expressed as a percentage of time away from the individual data samples. With longitudinal recorded media, a peak detection channel is often used to determine the locations of the stripes by detecting the peaks in each read-signal waveform. With perpendicular recorded media, however, a peak detection channel can no longer accurately detect the peaks in a signal waveform because the peaks in the signal waveform are not well defined. The perpendicular recorded signal observed from a magnetic tape usually has a large positive square pulse followed by a narrow small negative going pulse. Although this signal waveform may be low-pass filtered and then passed through a peak detection channel, the method throws away harmonics. Alternatively, Hilbert transformation may also be used but introduces noise and inter-symbol interference due to the lateral position (LPOS) and manufacturing data embedded in the LTO servo pattern.

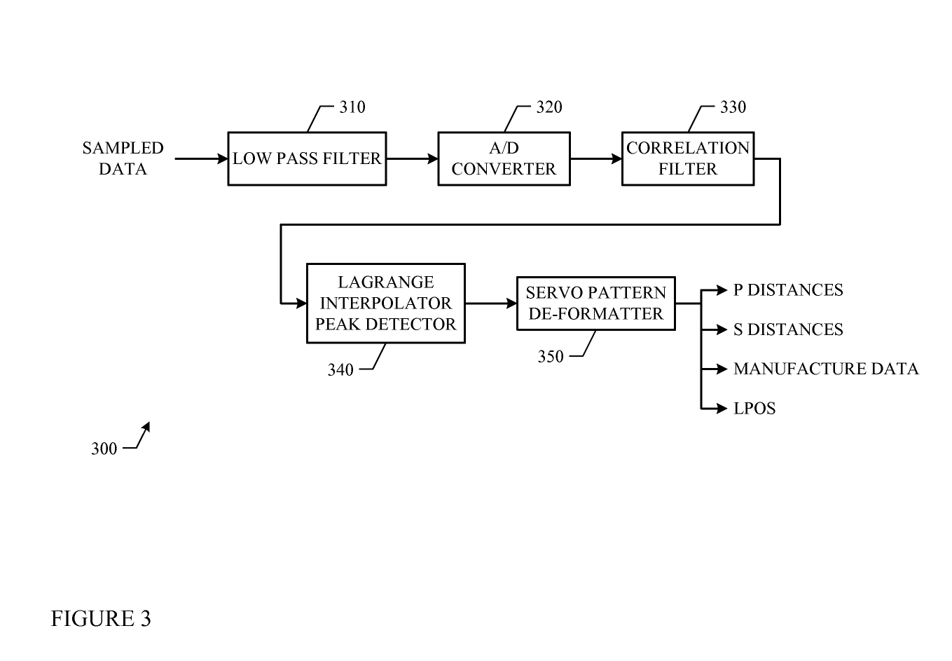

To improve the accuracy of detecting stripe locations on perpendicular recorded media, particular embodiments use cross correlation detection to detect the peaks in a signal waveform. FIG. 3 illustrates an example cross correlation channel 300. Note that with a multi-channel tape drive, there may be multiple such cross correlation channels 300. In particular embodiments, cross correlation channel 300 includes a low pass filter 310, an analog-to-digital (A/D) converter 320, a correlation filter 330, a Lagrange interpolator peak detector 340, and a servo pattern de-formatter 350. In particular embodiments, the analog sampled data, which is the signal from a servo read head, is the input signal to low pass filter 310. The analog output signal from low pass filter 310 (i.e., the signal resulting from low pass filter) becomes the input signal to A/D converter 320. A/D converter 320 coverts its analog input signal to digital output signal. The digital output signal of A/D converter 320 becomes the input signal to correlation filter 330, which matches its input signal against an predetermined reference signal. For this reason, correlation filter 330 may also be called a match filter. The output signal of correlation filter 330 becomes the input signal of Lagrange interpolator peak detector 340, which detects the peaks in its input signal. Finally, the output signal of Lagrange interpolator 340 becomes the input signal of servo pattern de-formatter 350, which determines the P distances (e.g., as illustrated in FIG. 1), the S distances (e.g., as illustrated in FIG. 1), the manufacturing data, LPOS and servo frame (e.g., as illustrated in FIG. 1).

The low pass filter removes noise and unwanted alias signals above ½ the sample frequency. An A/D converter, in general, is a device that converts continuous analog signals to discrete digital signals or numbers. The Lagrange interpolation is performed on a set of data points using a Lagrange polynomial to find the locations of the swipe peaks.

In particular embodiments, correlation filter 330 may be a finite impulse response (FIR) filter. In general, given a specific servo pattern (e.g., the servo pattern illustrated in FIG. 1), one may have a certain expectation on how the signal waveform from a servo read head should look like. Let this be referred to as the “reference signal waveform”. In particular embodiments, the reference signal waveform may be the ideal or near-ideal waveform that may be obtained from a servo read head for a given servo pattern. In particular embodiments, the actual signal waveform from the servo read head is matched against the reference signal waveform in order to detect the peaks in the actual signal waveform. In particular embodiments, correlation filter 330 in cross correlation channel 300 performs the matching process.

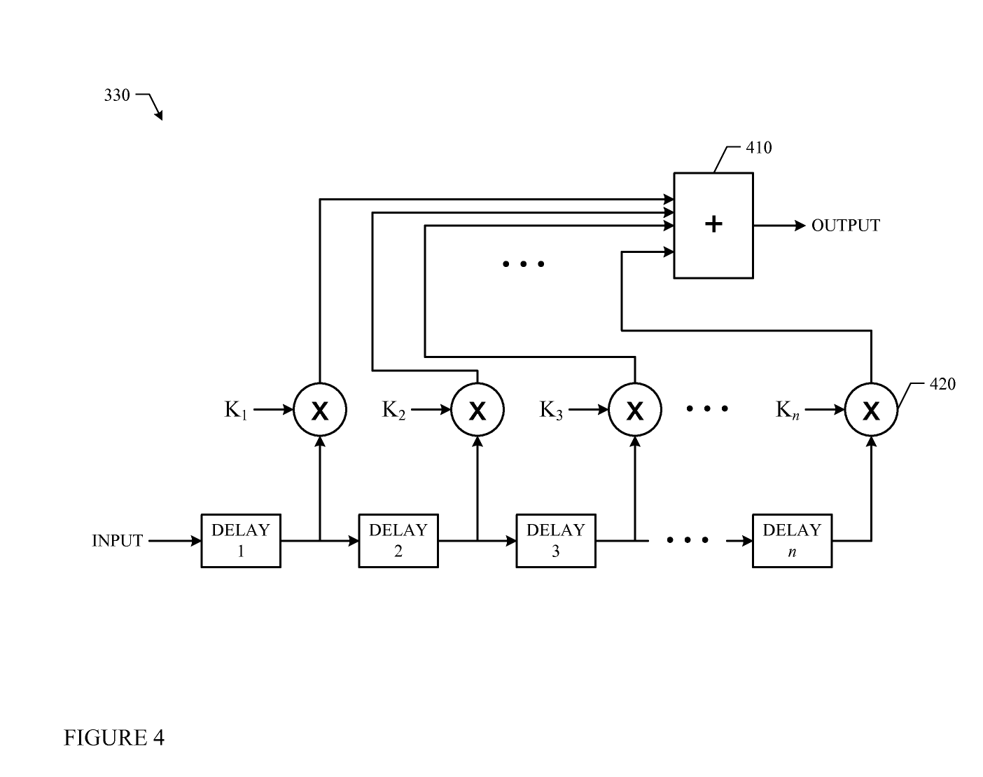

FIG. 4 illustrates an example correlation filter 330. In particular embodiments, correlation filter 330 may have a number of coefficients, K₁ to Kₙ, where n may be any positive number. In particular embodiments, the number of coefficients, n, may be determined based on the width of the pulse and the pulse or tape speed. The number of coefficients determine the length of the data-sample window. In particular embodiments, the length of the data-sample window is the same as or wider than the width of the waveform to be detected.

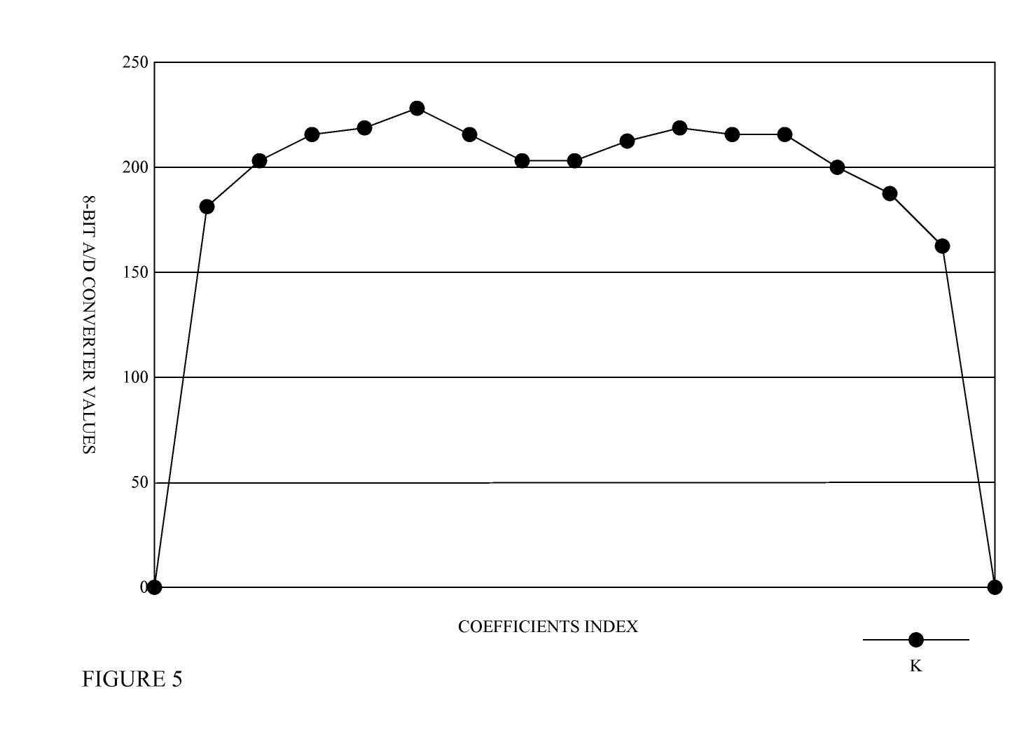

In particular embodiments, the values of the coefficients may be static and predetermined. In particular embodiments, the values of the coefficients are selected to match the reference signal waveform. FIG. 5 illustrates an example set of coefficients for a correlation filter. In particular embodiments, the input signal to correlation filter 330 is a digital signal (e.g., the output signal of A/D converter 320). In particular embodiments, the input signal goes through n delays, delay 1 to delay n, and the number of delays is the same as the number of coefficients of correlation filter 330. In particular embodiments, each delay is one sample time. Thus, at delay n, the input signal has been delayed n sample times with respect to delay 1. In particular embodiments, at each delay, the input signal is multiplied by the corresponding coefficient using a multiplier 420. For example, at delay 1, the input signal is multiplied by K₁; at delay 2, the input signal is multiplied by K₂; and so on. In particular embodiments, the output signal of correlation filter 330 is the sum of all the multiplications at the n delays, which may be calculated using an adder 410.

Since the coefficient values are selected to represent the reference signal waveform, the output from correlation filter 330 indicates how closely the actual signal waveform (i.e., the input to correlation filter 330) match the reference signal waveform. In particular embodiments, if the sum of the n multiplications is relatively large, then this suggests that the actual signal waveform matches relatively closely to the reference signal waveform. On the other hand, if the sum of the n multiplications is relatively small, then this suggests that the actual signal waveform does not match closely to the reference signal waveform. Moreover, a good match suggests that there is a peak in the waveform, and a bad match suggests that there is no peak in the waveform. In a sense, correlation filter 330 smoothes the input signal so that the peaks may be detected more accurately.

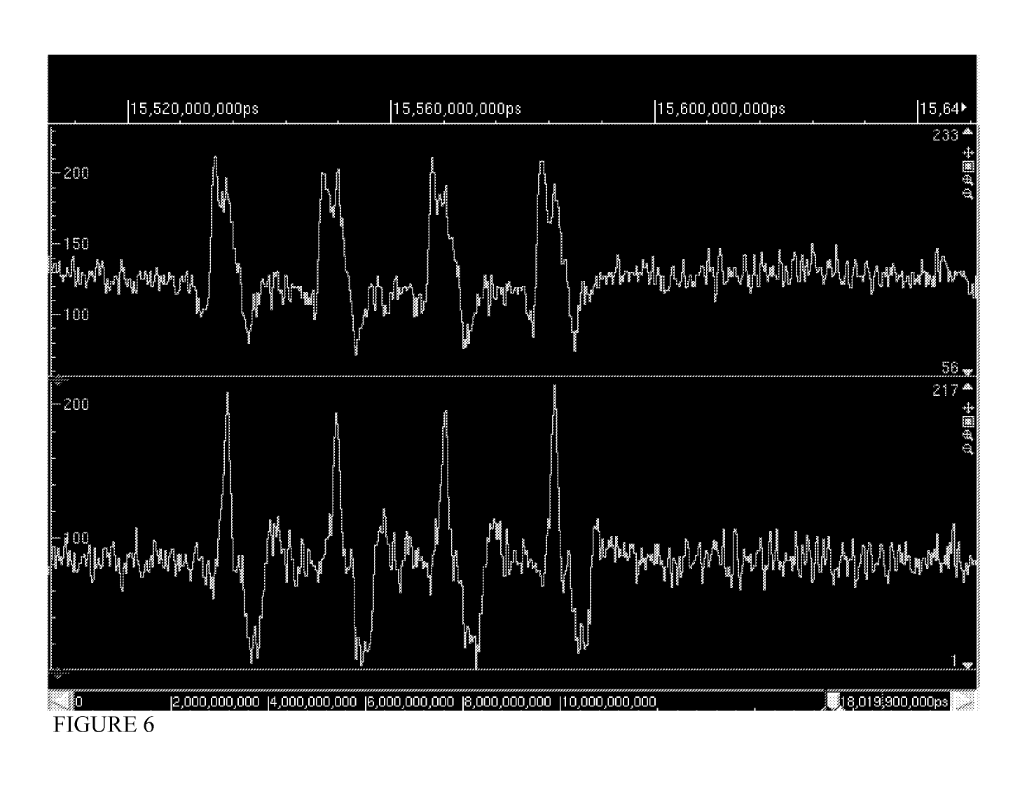

FIG. 6 illustrates an example input (the waveform on the top) and an example output (the waveform on the bottom) of the correlation filter. In this example, the input to the correlation filter is the servo signal. In particular embodiments, the output of correlation filter 330 may then be fed into Lagrange interpolator peak detector 340 in order to detect the peaks time.

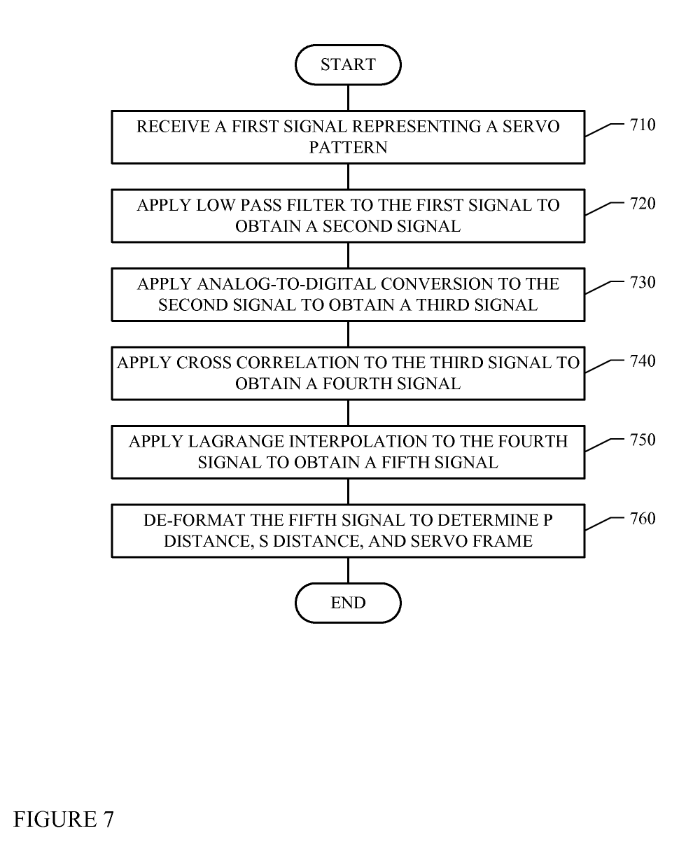

FIG. 7 illustrates an example method for detecting servo pattern on a perpendicular recorded media. Particular embodiments receive a first analog signal that represents a servo pattern (step 710), apply low pass filter to the first signal to obtain a second signal (step 720), apply A/D conversion to the second signal to obtain a third digital signal (step 730), smooth the third signal by matching it against a reference waveform to obtain a fourth signal (step 740), apply Lagrange interpolation peak detector on the fourth signal to detect the time of the peaks in the fourth signal and obtain a fifth signal (step 750), and de-format the fifth signal to determine the P distance, S distances, manufacturing data and LPOS in the servo frame (step 760).

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A servo processing circuit, comprising:
a correlation filter operable to:
receive a first signal as input;
correlate the first signal with a reference signal; and
produce a second signal as output, wherein the second signal indicates a correlation between the first signal and the reference signal; and
a Lagrange interpolator peak detector coupled to the correlation filter and operable to:
receive the second signal as input;
detect one or more peaks in the second signal; and
produce a third signal as output, wherein the third signal indicates one or more peak locations of the peaks in the second signal.

2. The servo processing circuit recited in claim 1, further comprising:
a low pass filter operable to:
receive a fourth signal as input, wherein the fourth signal represents a perpendicular recorded servo pattern comprising a plurality of stripes; and
produce a fifth signal as output by applying low pass filter to the fourth signal; and
an analog-to-digital converter coupled to the low pass filter and the correlation filter and operable to:
receive the fifth signal as input; and
produce the first signal by converting the fifth signal from analog form to digital form.

3. The servo processing circuit recited in claim 2, further comprising a servo pattern de-formatter coupled to the Lagrange interpolator peak detector and operable to:
receive the third as input;
determine one or more stripe locations of the stripes of the fourth signal based on the peak locations; and
produce a sixth signal as output, wherein the sixth signal indicates P distance, S distance, manufacturing data, LPOS, and Servo Frame.

4. The servo processing circuit recited in claim 1, wherein the correlation filter is a finite impulse response filter.

5. The servo processing circuit recited in claim 1, wherein:
the correlation filter has one or more filter coefficients;
each one of the filter coefficients has a static, predetermined value; and
the values of the filter coefficients correspond to the reference signal.

6. The servo processing circuit recited in claim 5, wherein to correlate the first signal with a reference signal, the correlation filter is operable to:
delay the first signal one or more sample times, wherein each one of the delays corresponds to one of the filter coefficients;
at each one of the delays, multiply the first signal by the corresponding filter coefficient; and
add one or more multiplication results corresponding to all the delays to obtain the second signal.

7. A method, comprising:
receiving, at a correlation filter, a first signal as input;
correlating, by the correlation filter, the first signal with a reference signal;
producing, by the correlation filter, a second signal as output, wherein the second signal indicates the correlation between the first signal and the reference signal;
receiving, at a Lagrange interpolator peak detector coupled to the correlation filter, the second signal as input;
detecting, by the Lagrange interpolator peak detector, one or more peaks in the second signal; and
producing, Lagrange interpolator peak detector, a third signal as output, wherein the third signal indicates one or more peak locations of the peaks in the second signal.

8. The method recited in claim 7, further comprising:
receiving, at a low pass filter, a fourth signal as input, wherein the fourth signal represents a perpendicular recorded servo pattern comprising a plurality of stripes;
producing, by the low pass filter, a fifth signal as output by applying low pass filter to the fourth signal;
receiving, at an analog-to-digital converter coupled to the low pass filter and the correlation filter, the fifth signal as input; and
producing, by the analog-to-digital converter, the first signal by converting the fifth signal from analog form to digital form.

9. The method recited in claim 8, further comprising:
receiving, at a servo pattern de-formatter coupled to the Lagrange interpolator peak detector, the third as input;
determining, by the servo pattern de-formatter, one or more stripe locations of the stripes of the fourth signal based on the peak locations; and
producing, by the servo pattern de-formatter, a sixth signal as output, wherein the sixth signal indicates P distance, S distance, manufacturing data, LPOS, and Servo Frame.

10. The method recited in claim 7, wherein the correlation filter is a finite impulse response filter.

11. The method recited in claim 7, wherein:
the correlation filter has one or more filter coefficients;
each one of the filter coefficients has a static, predetermined value; and
the values of the filter coefficients correspond to the reference signal.

12. The method recited in claim 11, wherein correlating the first signal with a reference signal comprises:
delaying the first signal one or more sample times, wherein each one of the delays corresponds to one of the filter coefficients;
at each one of the delays, multiplying the first signal by the corresponding filter coefficient; and
adding one or more multiplication results corresponding to all the delays to obtain the second signal.
